(19) United States
(12) Patent Application Publication
(10) Pub. No.: US 2026/0070641 A1
(43) Pub. Date: Mar. 12, 2026

(54) BOAT PROPULSION DEVICE AND BOAT

(71) Applicant: YAMAHA HATSUDOKI KABUSHIKI KAISHA, Iwata-shi (JP)

(72) Inventor: Takafumi TANIGUCHI, Shizuoka (JP)

(21) Appl. No.: 19/324,333

(22) Filed: Sep. 10, 2025

(30) Foreign Application Priority Data
Sep. 11, 2024 (JP) 2024-157192

(51) Int. Cl. B63H 21/30

(52) U.S. Cl. CPC B63H 21/30

(57) ABSTRACT

A boat propulsion device includes an engine, a propeller shaft, a transmission, a rotating member, a non-rotating member, an elastic member, a housing, a contact member, and a pusher. The transmission includes a drive gear and a driven gear. The rotating member is rotatable with the propeller shaft. Rotation of the non-rotating member is prevented. The elastic member exerts a force to cause the rotating member and the non-rotating member to contact each other. The housing includes a first surface sloping from a center outward in a radial direction. The housing rotates with the propeller shaft. The contact member contacts the first surface and is movable in the radial direction. The pusher includes a first portion contacting the contact member and a second portion contacting one of the rotating member and the non-rotating member located on another side in the axial direction.

### CROSS REFERENCE TO RELATED APPLICATIONS

This application claims the benefit of priority to Japanese Patent Application No. 2024-157192 filed on Sep. 11, 2024. The entire contents of this application are hereby incorporated herein by reference.

### BACKGROUND OF THE INVENTION

### 1. Field of the Invention

The technologies disclosed in this specification relate to boat propulsion devices and boats.

### 2. Description of the Related Art

A known boat propulsion device includes an engine, an output shaft, an input pinion that rotates by the driving force of the engine, a forward gear and a reverse gear that mesh with the input pinion, and an actuator. The actuator reduces rattling noise by braking the forward gear or backward gear. The actuator is driven electrically, hydraulically, or pneumatically (see, e.g., JP 4499876 B).

There is room for improvement in reducing the rattling noise of boat propulsion devices.

### SUMMARY OF THE INVENTION

Example embodiments of the present invention utilize technologies that are able to solve the above-described problem, and can be implemented in the following examples, for example.

A boat propulsion device includes an engine, a propeller shaft, a transmission, a rotating member, a non-rotating member, an elastic member, a housing, a contact member, and a pusher. The transmission is configured to transmit a propulsion force of the engine to the propeller shaft. The transmission includes a drive gear rotatable by the driving force of the engine and a driven gear to mesh with the drive gear. The rotating member is arranged around the propeller shaft. The rotating member is movable in an axial direction of the propeller shaft and rotatable around the propeller shaft along with a rotation of the propeller shaft. The non-rotating member is arranged around the propeller shaft and is adjacent to the rotating member in the axial direction. The non-rotating member is movable in the axial direction and non-rotatable around the propeller shaft. The elastic member is configured to push at least one of the rotating member and the non-rotating member to a first side of the propeller shaft in the axial direction and exert a force to cause the rotating member and the non-rotating member to come into contact with each other. The housing surrounds an outer circumference of the propeller shaft. The housing includes a first surface facing the a second side of the propeller shaft in the axial direction and is inclined so that it extends toward the second side of the propeller shaft in the axial direction from a center outward in a radial direction of the propeller shaft. The housing is rotatable around the propeller shaft along with the rotation of the propeller shaft. The contact member is configured to contact the first surface and is movable in the radial direction. The pusher is movable in the axial direction. The pusher includes a first portion that contacts an end of the contact member on the second side in the axial direction, and a second portion that contacts an end on the first side in the axial direction of one of the rotating member and the non-rotating member located on the second side in the axial direction.

The boat propulsion device described above can reduce rattling noise by applying friction to the propeller shaft through the action of an elastic member and can reduce the friction applied to the propeller shaft as the rotation speed of the propeller shaft increases.

Another boat propulsion device according to an example embodiment of the present invention includes an engine, a shaft, a transmission, a rotating member, a non-rotating member, an elastic member, a housing, a contact member, and a pusher. The transmission is configured to transmit a driving force of the engine to the shaft. The transmission includes a drive gear to rotate by the driving force of the engine and a driven gear to mesh with the drive gear. The rotating member is arranged around the shaft. The rotating member is movable in the axial direction of the shaft and rotatable around the shaft along with the rotation of the shaft. The non-rotating member is arranged around the shaft and is adjacent to the rotating member in the axial direction. The non-rotating member is movable in the axial direction and non-rotatable around the shaft. The elastic member is configured to push at least one of the rotating member and the non-rotating member to a first side of the shaft in the axial direction and exert a force to cause the rotating member and the non-rotating member to come into contact with each other. The housing surrounds an outer circumference of the shaft. The housing includes a first surface facing a second side of the shaft in the axial direction and inclined so that it extends toward the second side of the shaft in the axial direction from a center outward in the radial direction of the shaft. The housing is rotatable around the shaft along with the rotation of the shaft. The contact member is configured to contact the first surface and is movable in the radial direction. The pusher is movable in the axial direction. The pusher includes a first portion to contact an end of the contact member on the second side in the axial direction, and a second portion to contact an end on the first side in the axial direction of one of the rotating member and the non-rotating member located on the second side in the axial direction.

The boat propulsion device described above can reduce rattling noise by applying friction to the shaft through the action of the elastic member and can reduce the friction applied to the propeller shaft as the rotation speed of the shaft increases.

The technologies disclosed herein can be implemented in various applications and example embodiments including, e.g., outboard motors or boats including outboard motors and boat bodies.

Example embodiments of the boat propulsion devices disclosed herein can reduce rattling noise by applying friction to the shaft through the action of the elastic member and can reduce the friction applied to the propeller shaft as the rotation speed of the shaft increases.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating a configuration of a boat.

FIG. 2 is a side view schematically illustrating a configuration of an outboard motor.

FIG. 3 is an explanatory view illustrating a detailed configuration of an area around a propeller shaft.

FIG. 4 is a cross-sectional view of the outboard motor taken along line IV-IV in FIG. 3.

FIG. 5 is an explanatory view illustrating a detailed configuration of the area around the propeller shaft in a state where the rotation speed of the engine body is relatively low.

FIG. 6 is an explanatory view illustrating a detailed configuration of the area around the propeller shaft in a state where the rotation speed of the engine body is relatively high.

FIG. 7 is an explanatory view conceptually illustrating the force applied to a roller.

### DETAILED DESCRIPTION OF THE EXAMPLE EMBODIMENTS

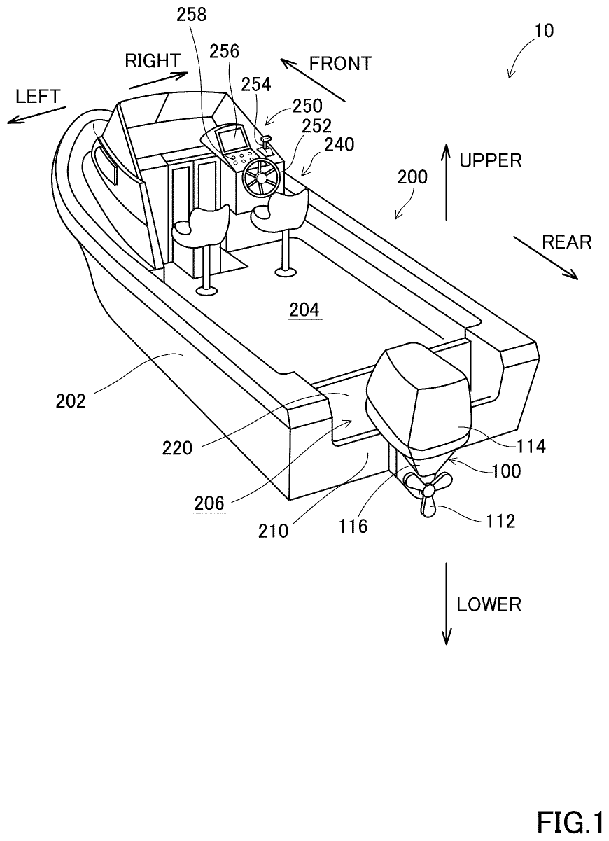

FIG. 1 is a perspective view schematically illustrating a configuration of a boat 10. FIG. 1 and other figures described below show arrows representing each direction with respect to the position of the boat 10. More specifically, each drawing shows arrows representing the front direction (FRONT), rear direction (REAR), left direction (LEFT), right direction (RIGHT), upper direction (UPPER), and lower direction (LOWER), respectively. The front-rear direction, left-right direction, and upper-lower (vertical) direction are orthogonal to each other. It should be noted that, in this specification, axes, members, and the like, extending in the front-rear direction need not necessarily be parallel to the front-rear direction. Axes and members extending in the front-rear direction include axes and members that are inclined in the range of ±450 to the front-rear direction. Similarly, axes and members extending in the upper-lower direction include axes and members inclined within a range of ±45° to the upper-lower direction, and axes and members extending in the left-right direction include axes and members inclined within a range of ±45° to the left-right direction.

The boat 10 includes a boat body 200 and an outboard motor 100. In this example embodiment, the boat 10 includes only one outboard motor 100, but the boat 10 may include multiple outboard motors 100.

The boat body 200 is the portion of the boat 10 for occupants to ride. The boat body 200 includes a boat main body 202, a pilot seat 240, and a steering device 250. The boat main body 202 includes a living space 204. The pilot seat 240 is located in the living space 204. The steering device 250 is located near the pilot seat 240. The steering device 250 steers the boat. The steering device 250 includes, e.g., a steering wheel 252, a shift/throttle lever 254, a monitor 256, and an input device 258. The boat body 200 also includes a partition wall 220 and a transom 210. The partition wall 220 partitions the rear end of the living space 204. The transom 210 is located at the rear end of the boat body 200. In the front-rear direction, there is a space 206 between the transom 210 and the partition wall 220.

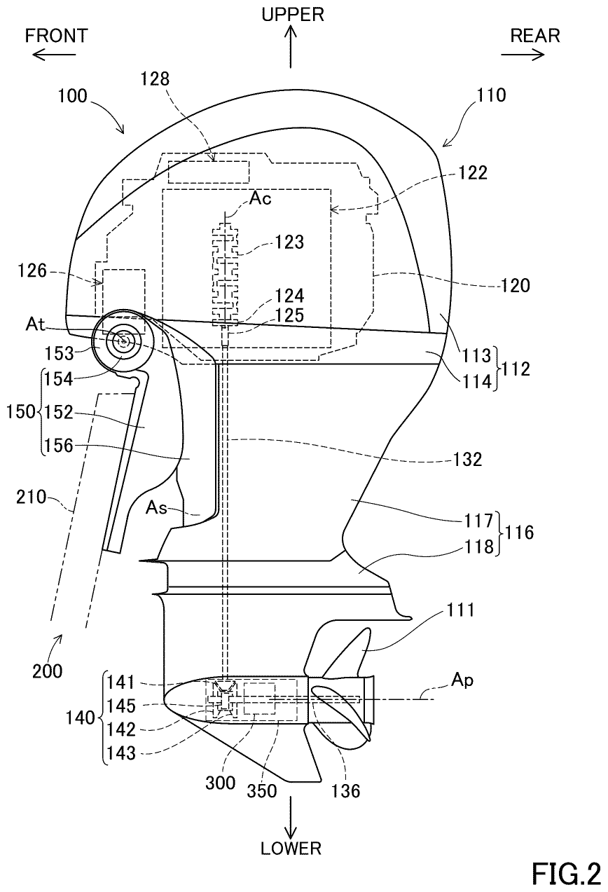

FIG. 2 is a side view schematically illustrating a configuration of an outboard motor 100. The outboard motor 100 in the reference attitude will be described below unless otherwise specified. The reference attitude is an attitude in which the rotation axis Ac of the crankshaft 123, which will be described below, extends in the upper-lower direction and the rotation axis Ap of the propeller shaft 136, which will be described below, extends in the front-rear direction. The front-rear direction, the left-right direction, and the upper-lower direction are respectively defined based on the outboard motor 100 in the reference attitude. The outboard motor 100 is an example of a boat propulsion device.

The outboard motor 100 generates thrust to propel the boat 10. The outboard motor 100 is attached to the transom 210 at the rear portion of the boat body 200. The outboard motor 100 includes an outboard motor main body 110 and a suspension device 150.

The outboard motor main body 110 includes an engine assembly 120, a cowl 112, a casing 116, a drive shaft 132, a propeller shaft 136, a propeller 111, a transmission 140, a silencer 300, and a housing 350.

The engine assembly 120 is an assembly of a plurality of elements, including an engine body 122. The engine assembly 120 includes, in addition to the engine body 122, intake system components 126 (e.g., throttle bodies, superchargers, and the like) and electrical components 128 (e.g., fuse boxes, ECUs, steering CUs, and the like). The engine assembly 120 is located in a relatively upper portion of the outboard motor 100.

The engine body 122 is a prime mover that generates power. The engine body 122 may be, e.g., an internal combustion engine. The engine body 122 includes a crankshaft 123 that converts the reciprocating motion of a piston, which is not shown in the figure, into rotational motion. The crankshaft 123 is arranged in an attitude in which its rotation axis Ac extends in an upper-lower direction. The crankshaft 123 includes a journal 124 and a spline 125. The journal 124 supports the crankshaft 123 itself in the bearing portion of the crankcase, which is not shown in the figure. The spline 125 includes multiple vertical grooves to connect with the drive shaft 132.

The cowl 112 is a housing body arranged in the upper portion of the outboard motor main body 110. The cowl 112 includes an upper cowl 113 and a lower cowl 114. The upper cowl 113 corresponds to the upper portion of the cowl 112. The lower cowl 114 corresponds to the lower portion of the cowl 112. The upper cowl 113 is removably attached to the lower cowl 114. The cowl 112 accommodates at least a portion of the engine assembly 120.

The casing 116 is a housing disposed in the lower portion of the outboard motor main body 110. The casing 116 is located below the cowl 112. The casing 116 includes an upper case 117 and a lower case 118. The upper case 117 corresponds to the upper portion of the casing 116. The lower case 118 corresponds to the lower portion of the casing 116.

The drive shaft 132 is a rod-shaped member that extends in the upper-lower direction. The upper end portion of the drive shaft 132 is connected to the spline 125 of the engine body 122. The drive shaft 132 extends downward from the connecting portion with the spline 125. The drive shaft 132 rotates together with the crankshaft 123 by the driving force of the engine body 122. At least a portion of the drive shaft 132 is accommodated in the casing 116.

The propeller shaft 136 is a rod-shaped member. The propeller shaft 136 is arranged in an attitude in which its rotation axis Ap extends in the front-rear direction at a relatively lower portion of the outboard motor main body 110. In other words, the axial direction of the propeller shaft 136 coincides with the front-rear direction of the outboard motor 100. One end of the propeller shaft 136 in the axial direction is located on the rear side of the outboard motor 100, and another end of the propeller shaft 136 in the axial direction is located on the front side of the outboard motor 100. The front end portion of the propeller shaft 136 is accommodated in the lower case 118. The rear end portion of the propeller shaft 136 protrudes rearward from the lower case 118. The propeller shaft 136 is an example of a shaft.

The propeller 111 is a rotating member including multiple blades. The propeller 111 is attached to the rear end portion of the propeller shaft 136. The propeller 111 rotates together with the propeller shaft 136. The propeller 111 rotates to generates thrust for the boat 10.

The transmission 140 transmits the driving force of the engine body 122 to the propeller shaft 136. The transmission 140 includes a first gear 141, a second gear 142, a third gear 143, and a dog clutch 145. The first gear 141 is an example of a drive gear. The second gear 142 and the third gear 143 are examples of driven gears.

The first gear 141 is connected to the lower end portion of the drive shaft 132. The first gear 141 rotates together with the drive shaft 132 by the driving force of the engine body 122. The rotation axis of the first gear 141 is parallel to the rotation axis Ac of the crankshaft 123. That is, the rotation axis of the first gear 141 is parallel to the upper-lower direction.

The second gear 142 and the third gear 143 are tubular gears that surround the front end portion of the propeller shaft 136. The rotation axes of the second gear 142 and the third gear 143 are parallel to the rotation axis Ap of the propeller shaft 136. That is, the rotation axes of the second gear 142 and the third gear 143 are parallel to the horizontal direction and perpendicular to the rotation axis of the first gear 141. The second gear 142 and the third gear 143 are each meshed with the first gear 141. This allows the driving force of the engine body 122 to be transmitted to the second gear 142 and the third gear 143 via the first gear 141.

The dog clutch 145 is arranged between the second gear 142 and the third gear 143 in the front-rear direction. The dog clutch 145 is tubular and surrounds the front end portion of the propeller shaft 136. The dog clutch 145 is connected to the propeller shaft 136, e.g., by a spline. The dog clutch 145 rotates together with the propeller shaft 136.

The dog clutch 145 is movable in the front-rear direction. More specifically, the dog clutch 145 is movable between a first connected position connecting with the second gear 142, a second connected position connecting with the third gear 143, and a disconnected position away from the second gear 142 and the third gear 143. When the dog clutch 145 is in the first connected position, the rotation of the second gear 142 is transmitted to the dog clutch 145, and the rotation of the dog clutch 145 is transmitted to the propeller shaft 136. As a result, the propeller 111 rotates in the direction that moves the boat 10 forward. When the dog clutch 145 is in the second connected position, the rotation of the third gear 143 is transmitted to the dog clutch 145, and the rotation of the dog clutch 145 is transmitted to the propeller shaft 136. As a result, the propeller 111 rotates in the direction that moves the boat 10 backward. When the dog clutch 145 is in the disconnected position, the rotation of the first gear 141 and second gear 142 is not transmitted to the dog clutch 145. As a result, the propeller 111 does not receive the driving force of the engine body 122. That is, when the dog clutch 145 is in the disconnected position, the outboard motor 100 is in a neutral state.

The silencer 300 and the housing 350 are located in a relatively lower portion of the outboard motor 100. The silencer 300 and the housing 350 are located in the lower case 118. Details of the silencer 300 and the housing 350 are described below.

The suspension device 150 connects the outboard motor main body 110 to the boat body 200. The suspension device 150 includes a pair of left and right clamp brackets 152, a tilt shaft 154, and a swivel bracket 156.

The pair of left and right clamp brackets 152 are disposed behind the boat body 200 in a state separated from each other in the left-right direction and are fixed to the transom 210 of the boat body 200 by using, e.g., bolts. Each clamp bracket 152 has a tubular supporting portion 153 provided with a through-hole extending in the left-right direction.

The tilt shaft 154 is a rod-shaped member and is rotatably supported within the through-hole in the supporting portion 153 of the clamp bracket 152. The tilt axis At, which is the centerline of the tilt shaft 154, corresponds to a horizontal (left-right) axis of the tilting action of the outboard motor 100.

The swivel bracket 156 is sandwiched between the pair of clamp brackets 152 and is supported by the supporting portion 153 of the clamp brackets 152 via the tilt shaft 154 so as to be rotatable around the tilt axis At. The swivel bracket 156 is driven to rotate about the tilt axis At with respect to the clamp bracket 152 by a tilt device (not shown) that includes an actuator, such as a hydraulic cylinder, for example.

When the swivel bracket 156 rotates about the tilt axis At with respect to the clamp bracket 152, the outboard motor main body 110 supported by the swivel bracket 156 also rotates about the tilt axis At. This achieves the tilting action of rotating the outboard motor main body 110 in the upper-lower direction with respect to the boat body 200. By this tilting action, the outboard motor 100 can change the angle of the outboard motor main body 110 around the tilt axis At in the range from the tilt-down state in which the propeller 111 is disposed under the water (the state in which the outboard motor 100 is in the reference attitude) to the tilt-up state in which the propeller 111 is disposed above the water surface. Trimming action to adjust the attitude of the boat 10 during travel can also be performed by adjusting the angle around the tilt axis At of the outboard motor main body 110.

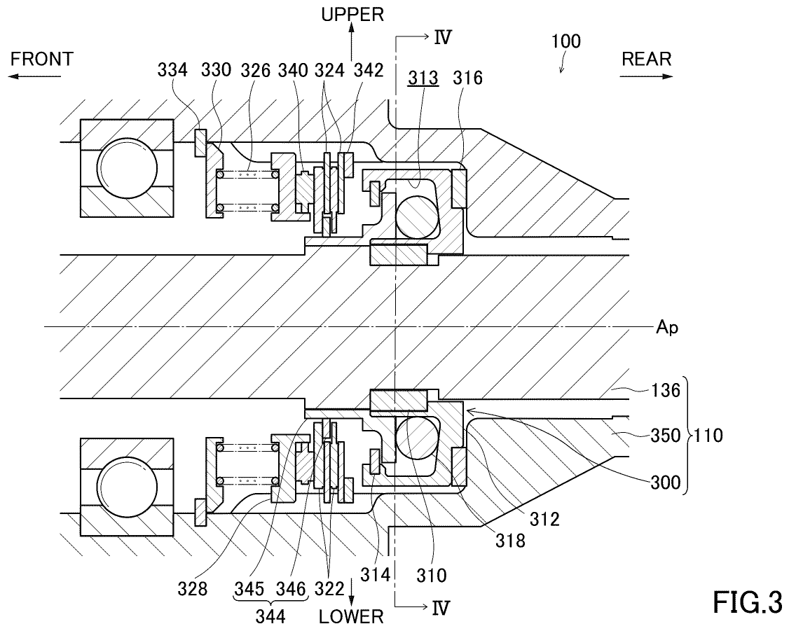

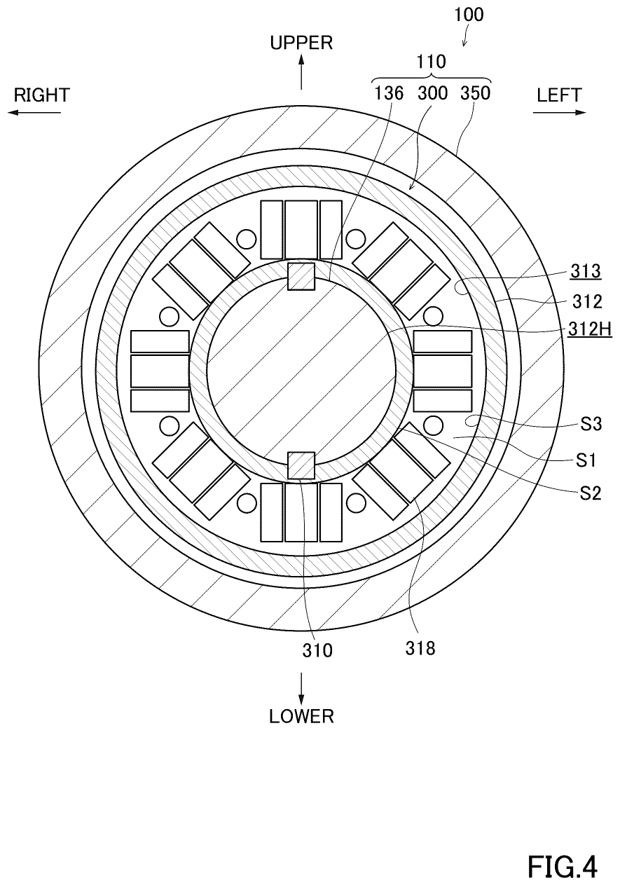

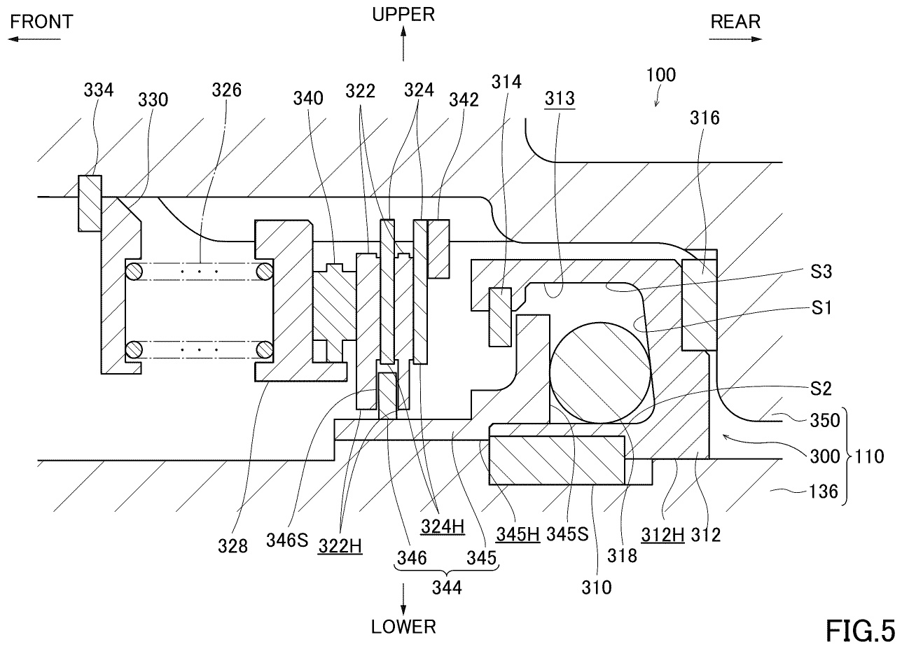

FIG. 3 is an explanatory view illustrating a detailed configuration of the area around the propeller shaft 136. FIG. 4 is a cross-sectional view of the outboard motor 100 taken along line IV-IV in FIG. 3. FIG. 5 is an explanatory view illustrating a detailed configuration of the area around the propeller shaft 136 in a state where the rotation speed of the engine body 122 is relatively low. FIGS. 3 and 5 show a cross-section of the outboard motor 100 perpendicular to the left-right direction. FIG. 4 shows a cross-section of the outboard motor 100 perpendicular to the front-rear direction.

The silencer 300 is an assembly of components arranged around the propeller shaft 136. As will be described below, the silencer 300 reduces the rattling noise that occurs between the first gear 141 and the second gear 142, and the rattling noise that occurs between the first gear 141 and the third gear 143, by applying friction to the propeller shaft 136. The housing 350 accommodates the silencer 300. In this example embodiment, oil is stored inside the housing 350. The housing 350 is an example of a case.

The silencer 300 includes a key 310, a roller housing 312, a snap ring 314, a thrust bearing 316, a roller 318, a disk 322, a plate 324, a coil spring 326, a pressure plate 328, a spring seat 330, a snap ring 334, a thrust bearing 340, a snap ring 342, and a pusher 344.

The key 310 is a prismatic member that extends in the front-rear direction. The key 310 is connected to a portion of the surface of the propeller shaft 136 that faces outward in the radial direction of the propeller shaft 136. The key 310 rotates together with the propeller shaft 136. In this example embodiment, the outboard motor 100 includes two keys 310 arranged at positions that differ from each other in the rotating direction of the propeller shaft 136. The two keys 310 are arranged at equal or substantially equal intervals from each other in the rotating direction of the propeller shaft 136.

The roller housing 312 includes a hole 312H in the center. The propeller shaft 136 and the key 310 are arranged in the hole 312H of the roller housing 312. The roller housing 312 surrounds the outer circumference of the propeller shaft 136 in the radial direction of the propeller shaft 136. The roller housing 312 surrounds the outer circumference of the key 310 in the radial direction of the propeller shaft 136. A portion of the surface of the roller housing 312 facing the hole 312H is connected to the key 310. The roller housing 312 rotates around the propeller shaft 136 together with the key 310 along with the rotation of the propeller shaft 136.

The roller housing 312 includes a housing space 313 that is open at the front side of the propeller shaft 136 in the axial direction. The roller housing 312 includes a first surface S1, a second surface S2, and a third surface S3, each of which faces the housing space 313. The first surface S1 faces the front side of the propeller shaft 136 in the axial direction. The first surface S1 is inclined so that it extends toward the front side of the propeller shaft 136 in the axial direction as it extends from a center outward of the propeller shaft 136 in the radial direction. The second surface S2 faces outward from the propeller shaft 136 in the radial direction. The second surface S2 corresponds to the inner circumferential surface of the housing space 313. The third surface S3 faces toward a center of the propeller shaft 136 in the radial direction. The third surface S3 corresponds to the outer circumferential surface of the housing space 313. The roller housing 312 is an example of the housing.

The snap ring 314 is a ring-shaped member. The snap ring 314 is attached to the roller housing 312 so that it protrudes from the third surface S3 of the roller housing 312 toward the center of the propeller shaft 136 in the radial direction.

The thrust bearing 316 is arranged between the roller housing 312 and the housing 350 in the front-rear direction. The roller housing 312 is connected to the housing 350 via the thrust bearing 316. Since the roller housing 312 is in contact with the thrust bearing 316, friction is reduced when it rotates along with the rotation of the propeller shaft 136. The thrust bearing 316 is an example of the second thrust bearing.

The roller 318 is located in the housing space 313 of the roller housing 312. The roller 318 is in contact with the first surface S1 of the roller housing 312. The roller 318 is able to move in the radial direction of the propeller shaft 136 by rolling in the radial direction of the propeller shaft 136. In this example embodiment, the outboard motor 100 includes eight rollers 318 arranged at positions that are different from each other in the rotating direction of the propeller shaft 136. The eight rollers 318 are arranged at equal or substantially equal intervals from each other in the rotating direction of the propeller shaft 136. The roller 318 is an example of a contact member.

The disk 322 is arranged around the propeller shaft 136. The disk 322 is located in front of the roller housing 312 and the rollers 318 of the propeller shaft 136 in the axial direction. The disk 322 is a plate-shaped member with a hole 322H in the center. The propeller shaft 136 is arranged in the hole 322H of the disk 322. The disk 322 surrounds the outer circumference of the propeller shaft 136. The disk 322 is movable of the propeller shaft 136 in the axial direction. The disk 322 rotates around the propeller shaft 136 along with the rotation of the propeller shaft 136. In this example embodiment, the outboard motor 100 includes two disks 322 that are arranged parallel to each other of the propeller shaft 136 in the axial direction. The disk 322 is an example of the rotating member.

The plate 324 is arranged around the propeller shaft 136. The plate 324 is located in front of the roller housing 312 and the rollers 318 of the propeller shaft 136 in the axial direction. The plate 324 is a plate-shaped member with a hole 324H in the center. The propeller shaft 136 is arranged in the hole 324H of the plate 324. The plate 324 surrounds the outer circumference of the propeller shaft 136. The size of the hole 324H in the plate 324 is larger than the size of the hole 322H in the disk 322. In other words, in the radial direction of the propeller shaft 136, the inner circumferential surface of the plate 324 is located outside the inner circumferential surface of the disk 322. The plate 324 is adjacent to the disk 322 of the propeller shaft 136 in the axial direction. The plate 324 is movable of the propeller shaft 136 in the axial direction. The plate 324 is prevented from rotating around the propeller shaft 136. That is, the plate 324 does not rotate around the propeller shaft 136. In this example embodiment, the outboard motor 100 includes two plates 324 that are arranged parallel to each other of the propeller shaft 136 in the axial direction. In addition, each of the disks 322 and each of the plates 324 are arranged alternately of the propeller shaft 136 in the axial direction. In this example embodiment, they are arranged in the order of the front-side disk 322, the front-side plate 324, the rear-side disk 322, and the rear-side plate 324, from the front side to the rear side. The plate 324 is an example of a non-rotating member.

The coil spring 326 is arranged around the propeller shaft 136. The coil spring 326 is a compression coil spring that expands and contracts in the front-rear direction. More specifically, the coil spring 326 is a multi-row coil spring in which two coil springs are arranged in a radial direction. The coil spring 326 pushes the front side disk 322 toward the rear side of the propeller shaft 136 in the axial direction by the elastic force of the coil spring 326. In other words, the coil spring 326 exerts a force to cause the disk 322 and the plate 324, which are arranged parallel of the propeller shaft 136 in the axial direction, to come into contact with each other. The coil spring 326 is an example of an elastic member.

The pressure plate 328 is arranged around the propeller shaft 136. The pressure plate 328 is located between the coil spring 326 and the disk 322/the plate 324 of the propeller shaft 136 in the axial direction. The pressure plate 328 is movable of the propeller shaft 136 in the axial direction. The pressure plate 328 is in contact with the coil spring 326 and transmits the elastic force of the coil spring 326 to the disk 322 and the plate 324.

The spring seat 330 is arranged around the propeller shaft 136. The spring seat 330 is arranged in front of the coil spring 326. The snap ring 334 is a ring-shaped member. The snap ring 334 is attached to the housing 350 so that it protrudes from the inner surface of the housing 350 toward a center of the propeller shaft 136 in the radial direction. The snap ring 334 is located in front of the spring seat 330. The spring seat 330 is in contact with the snap ring 334, which prevents the movement of the spring seat 330 of the propeller shaft 136 in the axial direction. In addition, the front end of the coil spring 326 is in contact with the spring seat 330, which prevents the movement of the coil spring 326 of the propeller shaft 136 in the axial direction.

The thrust bearing 340 is arranged around the propeller shaft 136. The thrust bearing 340 is located between the pressure plate 328 and the disk 322/the plate 324 of the propeller shaft 136 in the axial direction. The thrust bearing 340 is in contact with the pressure plate 328 and transmits the elastic force of the coil spring 326, which is transmitted through the pressure plate 328, to the disk 322 and the plate 324. The front side disk 322 is connected to the pressure plate 328 via the thrust bearing 340. The front side disk 322 is in contact with the thrust bearing 340 to reduce the friction when rotating along with the rotation of the propeller shaft 136. The thrust bearing 340 is an example of a first thrust bearing.

The snap ring 342 is attached to the housing 350 so that it protrudes from the inner surface of the housing 350 toward a center of the propeller shaft 136 in the radial direction. The snap ring 342 is located behind the disk 322 and the plate 324 of the propeller shaft 136 in the axial direction. At least one of the disk 322 and the plate 324 overlaps the snap ring 342 of the propeller shaft 136 in the axial direction. The movable ranges of the disk 322 and the plate 324 of the propeller shaft 136 in the axial direction are limited by the snap ring 342.

The pusher 344 is arranged around the propeller shaft 136. The pusher 344 is movable of the propeller shaft 136 in the axial direction. The pusher 344 includes a return hub 345 and a snap ring 346.

The return hub 345 includes a hole 345H in the center. The propeller shaft 136 is arranged in the hole 345H of the return hub 345. The return hub 345 surrounds the outer circumference of the propeller shaft 136. The return hub 345 contacts the front end of the roller 318 of the propeller shaft 136 in the axial direction. More specifically, the return hub 345 includes a surface 345S that faces the rear side of the propeller shaft 136 in the axial direction. The surface 345S of the return hub 345 is in contact with the roller 318. The return hub 345 is an example of a first portion.

The snap ring 346 is attached to the return hub 345 so that it protrudes from the surface of the return hub 345 facing outward from a center of the propeller shaft 136 in the radial direction. The snap ring 346 contacts the rear end of the disk 322, which is the one of the disk 322 and the plate 324 located at the front side of the propeller shaft 136, of the propeller shaft 136 in the axial direction. More specifically, the snap ring 346 is positioned behind the front-side disk 322 of the propeller shaft 136 in the axial direction. The snap ring 346 includes a surface 346S that faces the front side of the propeller shaft 136 in the axial direction. The surface 346S of the snap ring 346 comes into contact with the disk 322 as the pusher 344 moves toward the front side of the propeller shaft 136 in the axial direction. In addition, the outer circumferential surface of the snap ring 346 is located outward of the inner circumferential surface of the disk 322 and inward of the inner circumferential surface of the plate 324 in the radial direction of the propeller shaft 136. Therefore, the surface 346S of the snap ring 346 can come into contact with the disk 322 but not with the plate 324. The snap ring 346 is an example of a second portion.

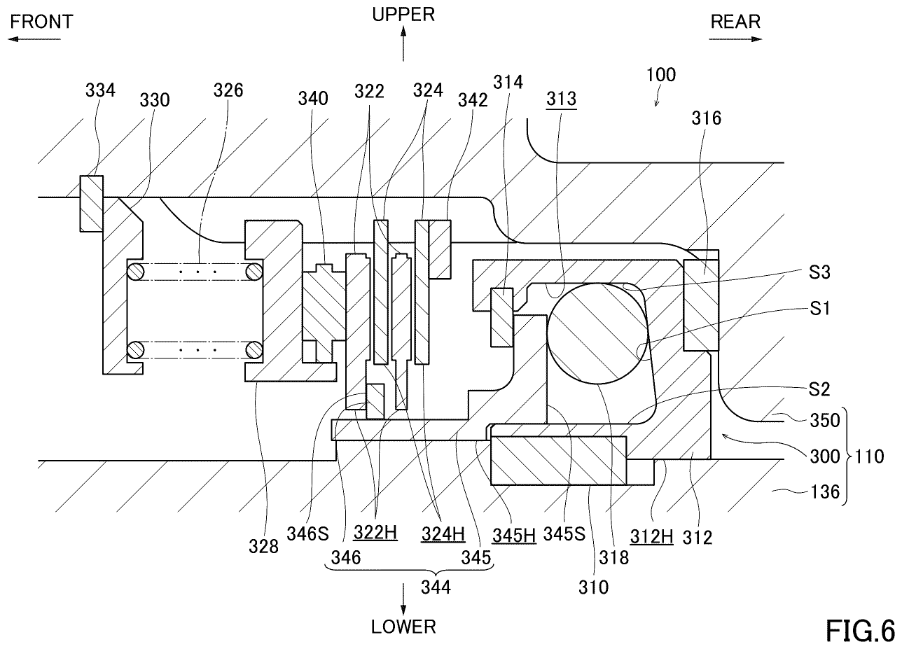

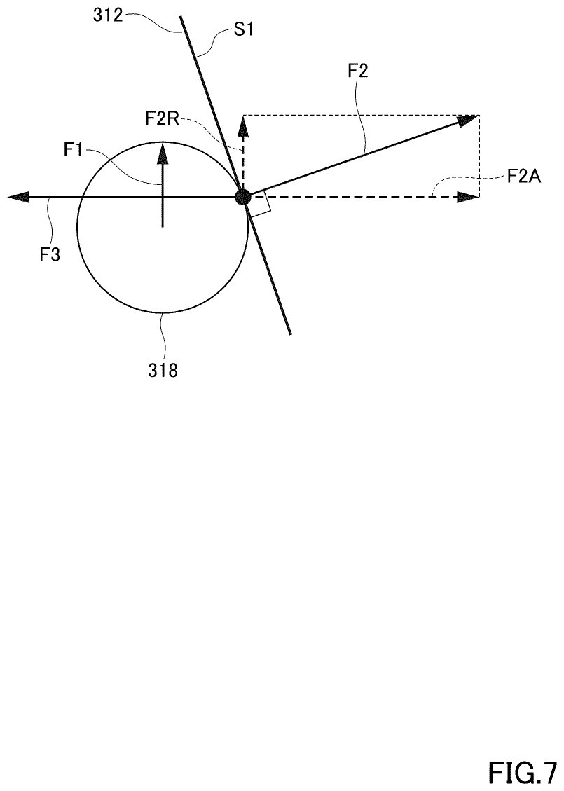

FIG. 6 is an explanatory view illustrating a detailed configuration of the area around the propeller shaft 136 in a state where the rotation speed of the engine body 122 is relatively high. FIG. 7 is an explanatory view conceptually illustrating the force applied to the roller 318. The operation of the silencer 300 will now be explained in detail with reference to FIGS. 5 to 7.

First, the operation of the silencer 300 when the rotation speed of the engine body 122 is relatively low will be explained with reference to FIG. 5. As mentioned above, the coil spring 326 exerts a force that causes the disk 322 and the plate 324 to come into contact with each other. Specifically, the coil spring 326 is a compression coil spring and is in a compressed state between the spring seat 330 and the pressure plate 328. Therefore, the coil spring 326 produces an elastic force in the direction of extension of the propeller shaft 136 in the axial direction. The pressure plate 328 receives the elastic force of the coil spring 326 to be pressed to the rear side of the propeller shaft 136 in the axial direction. The thrust bearing 340 receives the elastic force of the coil spring 326 via the pressure plate 328 to be pressed to the rear side of the propeller shaft 136 in the axial direction. The disk 322 and the plate 324 receive the elastic force of the coil spring 326 via the pressure plate 328 and thrust bearing 340 and are pressed to the rear side of the propeller shaft 136 in the axial direction. In other words, the elastic force that the disk 322 and the plate 324 receive is a force in the rearward direction of the propeller shaft 136 in the axial direction. As a result, the disk 322 and the plate 324 come into contact with each other.

As mentioned above, the disk 322 rotates around the propeller shaft 136 along with the rotation of the propeller shaft 136. On the other hand, the plate 324 is prevented from rotating around the propeller shaft 136. Therefore, in the state where the disk 322 and the plate 324 are in contact with each other, when the disk 322 rotates around the propeller shaft 136 in accordance with the rotation of the propeller shaft 136, a frictional force is generated between the disk 322 and the plate 324. As a result, e.g., when the rotation speed of the engine body 122 is relatively low, when the engine body 122 is not rotating, or when the rotation of the engine body 122 is not being transmitted to the propeller shaft 136 (i.e., when in a neutral state), the rotation of the disk 322 around the propeller shaft 136 is prevented. In other words, the coil spring 326 applies friction to the propeller shaft 136, which rotates together with the disk 322, by pushing the disk 322 and the plate 324 toward the rear side of the propeller shaft 136 in the axial direction.

The outboard motor 100 is likely to generate rattling noise when the rotation speed of the engine body 122 is relatively low. Specifically, e.g., when the rotation speed of the first gear 141 changes due to a change in the rotation speed of the engine body 122, the rotation speed of the second gear 142 and the third gear 143 cannot follow the rotation speed of the first gear 141, which causes the tooth surfaces to contact between the first gear 141 and the second gear 142 and between the first gear 141 and the third gear 143, causing a rattling noise. In an example embodiment of the outboard motor 100, by applying friction to the propeller shaft 136 when the rotation speed of the engine body 122 is relatively low, the rotation speed of the second gear 142 and the third gear 143 becomes easier to follow the rotation speed of the first gear 141. This reduces the rattling noise that occurs between the first gear 141 and the second gear 142, and the rattling noise that occurs between the first gear 141 and the third gear 143.

Next, the action of the silencer 300 when the rotation speed of the engine body 122 is relatively high will be explained with reference to FIGS. 6 and 7. When the rotation speed of the engine body 122 is relatively high, the coil spring 326 also produces an elastic force in the direction of extension of the propeller shaft 136 in the axial direction, in the same way as when the rotation speed of the engine body 122 is relatively low.

In addition, as described above, the roller housing 312 rotates around the propeller shaft 136 together with the key 310 along with the rotation of the propeller shaft 136. Therefore, the rollers 318 located in the roller housing 312 are subjected to the centrifugal force F1 generated by the rotation of the propeller shaft 136 (see FIG. 7). As described above, the rollers 318 are movable in the radial direction of the propeller shaft 136. Therefore, the roller 318 receives the centrifugal force F1 generated by the rotating propeller shaft 136 and tries to move from the center outward in the radial direction of the propeller shaft 136 inside the housing space 313.

The roller 318 is in contact with the first surface S1 of the roller housing 312. In this state, when the roller 318 tries to move from the center outward in the radial direction of the propeller shaft 136, the roller housing 312 receives a force from the roller 318. Specifically, the first surface S1 of the roller housing 312 is not parallel to the radial direction of the propeller shaft 136, but is inclined so that it extends toward the front side of the propeller shaft 136 in the axial direction from a center outward in the radial direction of the propeller shaft 136. Therefore, when the roller 318 tries to move outward in the radial direction of the propeller shaft 136, the roller housing 312 receives a force F2 in a direction perpendicular to the first surface S1 from the roller 318. At this time, roller 318 is also subjected to the reaction force F2. Specifically, the force F2 can be decomposed into a force F2A of the propeller shaft 136 in the axial direction and a force F2R in the radial direction of the propeller shaft 136. As a reaction to the force F2A, the roller 318 receives a force F3, which is a force of the propeller shaft 136 in the axial direction, from the roller housing 312. The force F3 is a forward force of the propeller shaft 136 in the axial direction. In addition, the pusher 344 receives the force F3 via the roller 318 because the return hub 345 is in contact with the forward end of the roller 318 of the propeller shaft 136 in the axial direction. The pusher 344, by receiving the force F3, tries to move in the forward direction of the propeller shaft 136 in the axial direction.

When the pusher 344 tries to move of the propeller shaft 136 in the axial direction, the snap ring 346 of the pusher 344 comes into contact with the rear end of the disk 322. Therefore, the disk 322 is subjected to the force F3 received via the pusher 344 and the elastic force of the coil spring 326. That is, the disk 322 is subjected to a forward force of the propeller shaft 136 in the axial direction and a backward force of the propeller shaft 136 in the axial direction. The force F3 that the disk 322 receives via the pusher 344 is the reaction force to the force F2 produced by the centrifugal force F1 associated with the rotation of the propeller shaft 136, so it increases as the speed of the propeller shaft 136 increases. Therefore, when the rotation speed of the propeller shaft 136 exceeds a certain value, the force F3 that the disk 322 receives via the pusher 344 exceeds the elastic force that the disk 322 receives from the coil spring 326. As a result, the disk 322, as the one of the disk 322 and the plate 324 located in the front side of the propeller shaft 136 in the axial direction, is pushed by the snap ring 346 of the pusher 344, and the disk 322 and the plate 324 move away from each other against the elastic force of the coil spring 326. In other words, the pusher 344 reduces the friction force generated between the disk 322 and the plate 324 by pushing the disk 322 forward of the propeller shaft 136 in the axial direction, thus reducing the friction applied to the propeller shaft 136.

The outboard motor 100 is less likely to generate rattling noise when the rotation speed of the engine body 122 is relatively high. In the outboard motor 100 of this example embodiment, when the rotation speed of the propeller shaft 136 exceeds a certain value, the friction applied to the propeller shaft 136 is reduced, thus reducing the occurrence of rattling noise and reducing the friction applied to the propeller shaft 136 along with the increase in the rotation speed of the propeller shaft 136.

The rotation speed of the engine body 122 to cause the disk 322 and the plate 324 to move away from each other can be set to any value by adjusting the spring constant of the coil spring 326, the mass of the roller 318, or the like. In this example embodiment, the disk 322 and the plate 324 are in contact with each other when the rotation speed of the engine body 122 is less than or equal to the trolling rotation speed, and they move away from each other when the rotation speed of the engine body 122 is greater than the trolling rotation speed.

The techniques disclosed herein are not limited to the above-described example embodiments and may be modified in various forms without departing from the gist of the present invention, including the following modifications.

The configuration of the boat 10 and the outboard motor 100 in the above-mentioned example embodiments is just one example, and can be modified in various ways. For example, in the above example embodiments, the boat propulsion device is exemplified by the outboard motor 100, the boat propulsion device may also be an inboard motor or a jet propeller.

In the above example embodiments, the outboard motor 100 includes only the engine body 122 as its drive source, but the boat propulsion device may also be a hybrid type that includes a motor in addition to the engine.

In the above example embodiments, the force F3 that the disk 322 receives via the pusher 344 is a force in the forward direction of the propeller shaft 136 in the axial direction, and the elastic force that the disk 322 receives from the coil spring 326 is a force in the backward direction of the propeller shaft 136 in the axial direction, but the directions are not limited to these. Specifically, the force that the rotating member receives via the pusher may be a force in the backward direction of the propeller shaft 136 in the axial direction, and the elastic force that the rotating member receives from the elastic member may be a force in the forward direction of the propeller shaft 136 in the axial direction. In the first place, the shaft of the boat propulsion device need not extend in the front-rear direction of the boat propulsion device.

In the above example embodiments, the outboard motor 100 is provided with a coil spring 326 as an elastic member, but the boat propulsion device may be provided with an elastic member other than a coil spring.

In the above example embodiments, the outboard motor 100 is provided with eight rollers 318, but the boat propulsion device only needs to be provided with at least one contact member.

In the above example embodiments, the outboard motor 100 is provided with the rollers 318 as the contact member, but the boat propulsion device may be provided with a contact member other than the roller.

In the above example embodiments, the outboard motor 100 is provided with a plurality of disks 322, but the boat propulsion device need only be provided with at least one rotating member. In the above example embodiments, the outboard motor 100 is provided with a plurality of plates 324, but the boat propulsion device need only be provided with at least one non-rotating member.

In the above example embodiments, the pusher 344 includes the return hub 345 and the snap ring 346, but the configuration is not limited thereto. For example, the pusher may be a single integrated piece consisting of the first portion and the second portion.

In the above example embodiments, the coil spring 326 pushes the disk 322 as the one of the disk 322 and the plate 324, but the elastic member may push the non-rotating member as the one of the rotating member and the non-rotating member.

In the above example embodiments, oil is stored inside the housing 350, but the inside of the case may not be stored with oil.

In the above example embodiments, the shaft is exemplified by the propeller shaft 136, but the shaft may be a shaft other than a propeller shaft.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A boat propulsion device comprising:
an engine;
a propeller shaft;
a transmission to transmit a propulsion force of the engine to the propeller shaft, and including:
a drive gear rotatable by the propulsion force of the engine; and
a driven gear to mesh with the drive gear;
a rotating member arranged around the propeller shaft and movable in an axial direction of the propeller shaft, the rotating member being rotatable around the propeller shaft along with a rotation of the propeller shaft;
a non-rotating member arranged around the propeller shaft, adjacent to the rotating member in the axial direction, and movable in the axial direction, the non-rotating member being non-rotatable around the propeller shaft;
an elastic member to push at least one of the rotating member and the non-rotating member to a first side of the propeller shaft in the axial direction and exert a force to cause the rotating member and the non-rotating member to come into contact with each other;
a housing to surround an outer circumference of the propeller shaft and including:
a first surface that faces a second side of the propeller shaft in the axial direction and is inclined so that it extends toward the second side of the propeller shaft in the axial direction from a center outward in the radial direction of the propeller shaft; wherein
the housing is rotatable around the propeller shaft along with the rotation of the propeller shaft;
a contact member to contact the first surface and movable in the radial direction; and
a pusher movable in the axial direction and including:
a first portion to contact an end of the contact member on the second side in the axial direction; and
a second portion to contact an end on the first side in the axial direction of one of the rotating member and the non-rotating member located on the second side in the axial direction.

2. The boat propulsion device according to claim 1, wherein
the contact member is movable outwardly in the radial direction due to centrifugal force generated by the rotation of the propeller shaft;
the pusher is movable to the second side in the axial direction by the contact member; and
the rotating member and the non-rotating member are movable away from each other by the second portion of the pusher pushing one of the rotating member and the non-rotating member located on the second side in the axial direction.

3. The boat propulsion device according to claim 2, wherein the rotating member and the non-rotating member are movable away from each other when a rotation speed of the engine is greater than a trolling rotation speed of the boat propulsion device.

4. The boat propulsion device according to claim 1, wherein
the propeller shaft extends in a front-rear direction of the boat propulsion device;
the first side in the axial direction is a rear side of the boat propulsion device; and
the second side in the axial direction is a front side of the boat propulsion device.

5. The boat propulsion device according to claim 1, wherein the elastic member includes a coil spring.

6. The boat propulsion device according to claim 1, wherein the elastic member includes a multi-row coil spring in which multiple coil springs are arranged in the radial direction.

7. The boat propulsion device according to claim 1, wherein the contact member includes a plurality of contact members.

8. The boat propulsion device according to claim 7, wherein the plurality of contact members are arranged at equal or substantially equal intervals in a rotating direction of the propeller shaft.

9. The boat propulsion device according to claim 1, wherein the contact member includes a roller to roll in the radial direction.

10. The boat propulsion device according to claim 1, further comprising:
a pressure plate arranged around the propeller shaft and located between the elastic member and either the rotating member or the non-rotating member in the axial direction.

11. The boat propulsion device according to claim 10, further comprising:
a first thrust bearing arranged around the propeller shaft and located between the pressure plate and either the rotating member or the non-rotating member in the axial direction.

12. The boat propulsion device according to claim 1, wherein the rotating member includes a plurality of rotating members, and the non-rotating member includes a plurality of non-rotating members.

13. The boat propulsion device according to claim 12, wherein each of the plurality of rotating members and each of the plurality of non-rotating members are arranged alternately in the axial direction.

14. The boat propulsion device according to claim 1, wherein
the first portion of the pusher includes a return hub; and
the second portion of the pusher includes a snap ring attached to the return hub.

15. The boat propulsion device according to claim 1, wherein the elastic member is configured to push the rotating member in the axial direction and exert a force to cause the rotating member and the non-rotating member to come into contact with each other.

16. The boat propulsion device according to claim 1, further comprising:
a case to accommodate the rotating member, the non-rotating member, the elastic member, the housing, the contact member, and the pusher; and
a second thrust bearing; wherein
the housing is connected to the case via the second thrust bearing.

17. The boat propulsion device according to claim 1, further comprising:
a drive shaft to rotate by the propulsion force of the engine; wherein
the drive gear is rotatable together with the drive shaft; and
the transmission is movable between a connected position that connects with the driven gear and a disconnected position that moves away from the driven gear, and includes a dog clutch to rotate together with the propeller shaft.

18. The boat propulsion device according to claim 1, further comprising:
a case to accommodate the rotating member, the non-rotating member, the elastic member, the housing, the contact member, and the pusher; wherein
oil is to be stored inside the case.

19. A boat comprising:
a boat body; and
the boat propulsion device according to claim 1 attached to a rear portion of the boat body.

20. A boat propulsion device comprising:
an engine;
a shaft;
a transmission to transmit a propulsion force of the engine to the shaft, and including:
a drive gear to rotate by the propulsion force of the engine; and
a driven gear to mesh with the drive gear;
a rotating member arranged around the shaft and movable in an axial direction of the shaft, the rotating member being rotatable around the shaft along with a rotation of the shaft;
a non-rotating member arranged around the shaft, adjacent to the rotating member in the axial direction, and movable in the axial direction, the non-rotating member being non-rotatable around the shaft;
an elastic member to push at least one of the rotating member and the non-rotating member to a first side of the shaft in the axial direction and exert a force to cause the rotating member and the non-rotating member to come into contact with each other;
a housing to surround an outer circumference of the shaft and including:
a first surface that faces a second side of the shaft in the axial direction and is inclined so that it extends toward the second side of the shaft in the axial direction from a center outward in the radial direction of the shaft; wherein
the housing is rotatable around the shaft along with the rotation of the shaft;
a contact member to contact the first surface and movable in the radial direction; and
a pusher movable in the axial direction and including:
a first portion to contact an end of the contact member on the second side in the axial direction; and
a second portion to contact an end on the first side in the axial direction of one of the rotating member and the non-rotating member located on the second side in the axial direction.
